(19) United States
(12) Patent Application Publication
(10) Pub. No.: US 2006/0238373 A1
(43) Pub. Date: Oct. 26, 2006

(54) ELECTRONIC DEVICE/SYSTEM WITH CUSTOMIZED REMOTE CONTROL MECHANISM AND METHOD THEREOF

(76) Inventor: Chi-Ming Sung, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/307,475

(22) Filed: Feb. 9, 2006

(30) Foreign Application Priority Data
Apr. 25, 2005 (TW) 094113119

(51) Int. Cl. G08C 19/12; G08C 19/00

(52) U.S. Cl. 340/825.72; 341/176

(57) ABSTRACT

Electronic device/system with customized remote control mechanism and method thereof. The electronic device works under a setup mode for showing functions of the electronic devices to a user, and instructs the user to perform a customized operation on the remote controller for a user-defined function, such as pressing a user-selected button on the remote controller. While receiving a remote signal triggered by the customized operation, the electronic device can correlate the customized operation to the user-defined function. After exiting the setup mode, the electronic device can work under a normal mode for receiving the remote signals of the remote controller, analyzing which customized operation is performed on the remote controller, and then executing the function corresponding to the performed customized operation.

### BACKGROUND OF THE INVENTION

1. Field of the Invention

The invention relates to an electronic device/system with a customized remote control mechanism and method thereof, and more particularly, to an electronic device/system capable of providing a user interface to help the user establish a customized remote control mechanism/set customized remote controller and method thereof.

2. Description of the Prior Art

As electronic techniques have been successfully applied and greatly advanced. As a result, these electronic devices have become a part of modern life. For example, consumer products, such as TV display for playing video and multimedia, CD players, DVD players, are all well known and utilized everywhere. In order to provide the user to use an easily-controlled interface for every electronic device, each of electronic devices has a corresponding remote controller, especially a wireless remote controller so that the user can control the electronic device through the remote controller.

As is known by those skilled in the art, the current remote control technique is characterized by a one to one relationship. In other words, each electronic device has only one specific remote controller. In the above-mentioned remote control technique, each function of an electronic device fixedly corresponds to a remote signal, which has specific information. The specific remote controller of the electronic device often comprises buttons, which correspond to different functions. In other words, a button for controlling to a specific function can make the remote controller output the remote signal (e.g., infrared rays or electromagnetic remote signals) having the specific information related to the function. When the user wants to control the electronic device to execute a certain function, the user can push the button corresponding to the function so that the remote controller outputs the remote signal carrying the related information of the particular function. When the electronic device receives the remote signal, the electronic device determines the specific information of the remote signal and then executes the corresponding function according to the corresponding relationship between the specific information and the function.

However, the above-mentioned prior art remote control mechanism has its disadvantages. Because the corresponding relationship between specific information of each remote signal and each function has been stored in the electronic device, the electronic device can only be controlled by its specific remote controller. That is, if other remote controllers are being used, the remote signals of other remote controller do not carry the specific information of the electronic device, even in the situation where the electronic device receives remote signals outputted by other remote controllers, the electronic device cannot know which function is going to be executed. In other words, the above-mentioned one-to-one relationship may cause an inconvenience to the user. This means that when the user loses the specific remote controller or the specific remote controller is out of order, the user has to find another specific remote controller corresponding to the electronic device. Furthermore, other type of remote controllers cannot replace the specific remote controller. The remote controller is inconvenient, increases cost and wastes time.

To sum up, the specific remote controller is inconvenient for the user, because the user has only one choice for selecting the only specific remote controller. In addition, some specific remote controllers have many functions resulting in a proliferation of buttons on the remote controllers. However, because of the one-to-one relationship between the specific remote controller and the electronic device, the user still must accept the specific remote controller instead of choosing the desired remote controller. Furthermore, the user cannot define the button/operation function of the specific remote controller.

### SUMMARY OF THE INVENTION

It is therefore one of the primary objectives of the claimed invention to provide an electronic device/system with a customized remote control mechanism and method thereof so that the user can define the button function and choose a desired remote controller to establish the remote control mechanism for solving the above-mentioned problem of the prior art remote control mechanism.

For the electronic device, the relationship between each function and the specific information of each remote signal can be defined by the user. In addition, the electronic device can operate in a setup mode. In the setup mode, the user can change the specific information of each remote signal corresponding to each function so that the user can define the operations of the remote controller. Similarly, the user can choose the desired remote controller in this mode. Furthermore, the electronic device can receive the remote signal outputted by the customized remote controller, cause the specific information of the remote signal to correspond to each function of the electronic device, and stored the new relationship. Therefore, when the user utilizes the customized remote controller to output the remote signal, the electronic device can execute corresponding functions according to the stored corresponding relationships such that the user can utilize the customized remote controller and remote control mechanism to control the electronic device.

In addition, in the setup mode, the electronic device can utilize a visual picture or sounds to cooperate with the buttons on the electronic device in order to achieve a user interface. Because of the user interface, the claimed invention can firstly show each remote control function of the electronic device. In addition, the user can select a function through the user interface. Then, the user interface can show the user how to perform a re-defining operation in order to correspond to the selected function. Therefore, the user can select an easy button of the remote controller to output corresponding remote signal. And then the electronic device can receive the remote signal outputted by the remote controller, store the specific information carried in the remote signal, set the corresponding relationship between the specific information and the selected function, and store the corresponding relationship. After the setup mode is performed completely, when the user pushes the same button to output the remote signal, the electronic device can execute the aforementioned selected function according to the stored corresponding relationship. In other words, the re-defining remote control mechanism can be accomplished through aforementioned steps.

In contrast to the prior art, the electronic device/system and related remote control mechanism have the following advantages. First, the user can define the button function of a remote controller. This makes the button function more suitable for the user. Moreover, the user can choose any other remote controllers. Moreover, after the chosen remote controller is set up in the setup mode, the user can operate the selected remote controller to control the electronic device. Therefore, this can reduce cost and save time associated with the remote control mechanism, and meet different demands of remote control mechanism/remote controller according to the different users.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an electronic system composed of an electronic device and a remote controller according to the present invention.

FIG. 2 is a diagram illustrating the electronic device shown in FIG. 1 as it operates in a setup mode according to the present invention.

FIG. 3 is a diagram illustrating the electronic device shown in FIG. 1 as it operates in a normal mode according to the present invention.

FIG. 4 is a diagram illustrating a flow of a setup procedure in a setup mode.

FIG. 5 is a diagram illustrating that a user interface of the visual screen is utilized to perform the flow shown in FIG. 4.

FIG. 6 is a diagram of a data structure of each remote signal carrying related information.

FIG. 7 is a diagram of a receiving module of the electronic device shown in FIG. 1 of an embodiment according to the present invention.

FIG. 8 and FIG. 9 are diagrams of the electronic system of two embodiments according to the present invention.

### DETAILED DESCRIPTION

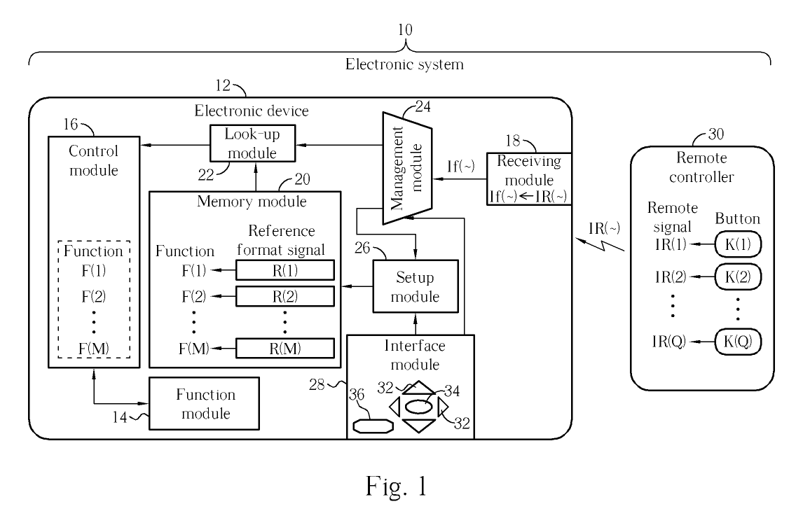

Please refer to FIG. 1, which is a block diagram of an electronic system 10 composed of an electronic device 12 and a remote controller 30 according to the present invention. Please note that the electronic device 12 can be (but is not limited to) a multimedia playback device, such as a TV, a display, a CD player, a DVD player, a recorder, an amplifier, or any other consumer products (e.g., an air conditioner). As shown in FIG. 1, the electronic device 12 comprises a function module 14, a control module 16, a memory module 20, a look-up module 22, and a receiving module 18. The electronic device 12 further comprises a management module 24, a setup module 26, and an interface module 28. The remote controller 30 is utilized to support the remote control mechanism such that the user can control the electronic device 12 through the remote controller 30.

In the electronic device 12, the function module 14 is utilized to execute each function F(1), F(2), . . . , F(M) of the electronic device 12. The control module 16 is utilized to control the operation of the function module 14 and to determine which function the function module 14 is to be executed. For example, if the electronic device 12 is a TV or a display, the function module 14 can comprise the display screen and related driving circuits. And each function F(1), F(2), . . . , F(M) can be “power on”, “sound adjustment”, “luminance adjustment”, and so on. On the other hand, if the electronic device 12 is an optical disc (e.g., a DVD disc) player, the function module 14 can comprise the motor, utilized for rotating the optical disc, the pickup head, utilized for reading optical disk, and other hardware. And the function F(1), F(2), . . . , F(M) can be “power on”, “eject”, “play”, “pause”, “previous/next”, “FF/FB”, and “SF/SB”. The control module 16 can be a microprocessor for controlling the function module 14. In addition, the remote controller 30 can comprise a plurality of buttons K(1) through K(Q). Each button respectively corresponds to different remote signals IR(1) through IR(Q), wherein each of the different remote signals carries different specific information. When the user pushes a certain button K(q), where q=1˜Q, the remote controller 30 can output the corresponding remote signal IR(q). Please note that the remote signal can be a wireless signal, such as an infrared ray or electromagnetic remote signal.

Corresponding to the remote controller 30, the receiving module 18 of the electronic device 12 can receive each remote signal IR(q) outputted by the remote controller 30, and provide a corresponding format signal If(q) according to related information/specific information carried by the remote signal IR(q). Please note that in FIG. 1 and in the following figures. IR(˜) represents remote signals outputted by the remote controller, and If(˜) represents format signals corresponding to the remote signal. On the other hand, in order to establish the remote control mechanism of the electronic device 12, the memory module 20 of the electronic device 12 can store a plurality of format signals R(1) through R(M), where each format signal R(1) through R(M) respectively corresponds to each function F(1) through F(M) of the electronic device 12. When the electronic device 12 is being remotely controlled, the receiving module 18 provides a corresponding format signal If(q) after receiving a remote signal IR(q). And the look-up module 22 can determine whether the format signal If(q) complies with one of the reference format signals according to the records stored in the memory module 20. If the format signal complies with a reference format signal R(m), where m=1˜M, the control module 16 can control the function module 14 to start performing the function F(m), where m=1˜M, corresponding to the reference format signal R(m), according to the correspondence relationship in the memory module 20.

As mentioned previously, in the prior art remote control mechanism, the corresponding relationship between the specific information of the remote signal and the function is fixedly embedded, and cannot be changed (especially cannot be changed by users.) In other words, assuming that the electronic device 12 utilizes the prior art (that is, the electronic device 12 needs to work in coordination with the specific remote controller 30 in order to establish the remote control mechanism), we could know that the corresponding relationship stored in the memory module 20 cannot be changed. Each reference format signal is fixedly equal to a format signal If(˜). This makes the relationship between the electronic device and the remote controller a one-to-one relationship. Therefore, if other remote controllers are utilized to control the electronic device 12, because the specific information carried by the remote signals outputted by other remote controllers do not comply with the specific format signal If(˜), the electronic device 12 cannot be remote controlled by other remote controllers.

In contrast to the prior art, the present invention can allow the user to define the content (definition) of each reference format signal such that the user can reset the remote control mechanism according to his needs. That is, the user can establish a customized remote control mechanism to break the limitations of the prior art remote control mechanism. In order to achieve the technique of the present invention, the present invention setup module 26 of the electronic device 12 can be utilized to reset the content of each reference format signal. This can make each reference format signal not fixedly equal to the format signal carried by a remote signal. After the setup module 26 resets the content, the reference format signal can be changed to be a format signal carried by another remote signal. This allows the user to re-define the button function of the specific remote controller. Similarly, the reference format signal can be the format signal of the remote signal outputted by other remote controllers. Therefore, the user can select other remote controllers to establish the remote control mechanism of the electronic device 12.

In coordination with the setup module 26, the interface module 28 of the electronic system 10 can provide a user interface (UI) such that the user can establish a re-defined remote control mechanism through the user interface. In addition, the management module 24 can be utilized to control whether the re-defining operation needs to be performed. The management module 24 can switch the electronic device 12 to a setup mode or a normal mode. In other words, the user can trigger the management module 24 through using the interface module 28 in order to switch the electronic device 12 to the setup mode and the normal mode. In the setup mode, the user can further control the setup module 26 through the interface module 28 in order to reset the content/definition of each reference format signal. In the normal mode, the electronic device 12 can operate normally according to the re-defined remote control mechanism. This allows the user to utilize customized button function or a customized remote controller to control the electronic device 12. In a preferred embodiment of the present invention, the interface module 28 can comprise buttons 32, 34, and 36. The buttons 32, 34, and 36 help the user trigger the setup mode/normal mode and select the reference format signal to be re-defined.

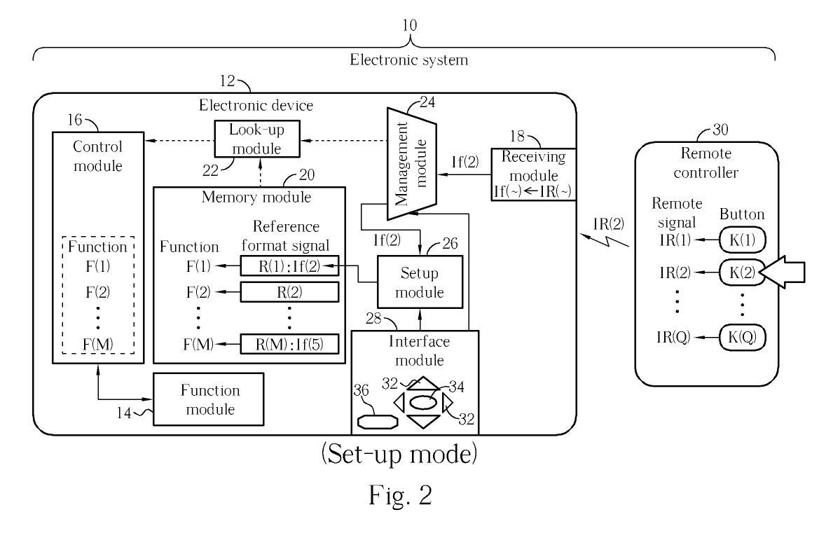

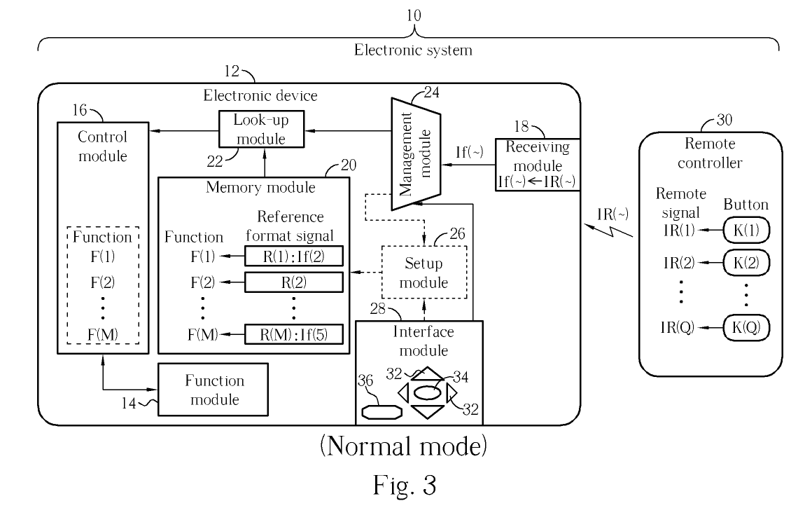

In order to further illustrate the electronic device 12 as it operates in each of the modes, please refer to FIG. 2 and FIG. 3 (in conjunction with FIG. 1). FIG. 2 and FIG. 3 respectively show the electronic device 12 as it operates in a setup mode and a normal mode. First, as shown in FIG. 2, when the user wants to reset the remote control mechanism of the electronic device 12, the user can trigger the electronic device through the user interface provided by the interface module 28 for operating in the setup mode. In the embodiment shown in FIG. 2, assume that the user wants to utilize the button K(2) of the remote controller 30 to control the function F(1) of the electronic device 12. Therefore, the user can select the function F(1) to be reset through the information shown by the user interface, and the setup module 26 can prepare to redefine the reference format signal R(1) corresponding to the function F(1). And then, the user interface can show the user how to perform a re-defining operation (i.e., that is, to push the button K(2)) such that the remote controller 30 outputs a corresponding remote signal IR(2). After receiving the remote signal IR(2), the receiving module 18 can provide a corresponding format signal If(2) according to its related information. And then, the management module 24 transfers the format signal If(2) to the setup module 26 (but not to the look-up module 22). And then, the setup module 26 can store the format signal If(2) in the memory module 20 as a reference format signal R(1). Therefore, the button K(2) can be utilized to control the function F(1). After the remote control mechanism of the function F(1) is set up, the user interface can show the user how to setup other functions. For example, if the user wants to utilize the button K(5) to remote control the function F(M), the user can select the function F(M) through the user interface such that the setup module 26 prepares the corresponding format signal R(M). And then, the user interface can inform the user to perform the re-defining operation on the function F(M). That is, the user pushes the button K(5) to be re-defined. Therefore, through the operations of remote controller 30, the receiving module 18, management module 24, and the setup module 26, the reference format signal R(M) inside the memory module 20 can be redefined as the reference signal IF(5). In other words, through the relationships “button K(5)—remote signal IR(5)—format signal If(5)—reference format signal R(M)—function F(M)”, the button K(5) can finally correspond to the function F(M).

After the customized remote control mechanism is set up in the setup mode, the definition of each reference format signal is stored in the memory module 20. Therefore, the user can cause the management module 24 to exit the setup mode through the operation of the interface module 28. After the setup mode is finished, the management module 24 can switch the electronic device 12 into the normal mode. As shown in FIG. 3, in the normal mode, the user can utilize the aforementioned customized (i.e., redefined) remote control mechanism in the setup mode to remote control the electronic device 12. In the normal mode, the setup mode 26 can pause operation. When the user pushes the button of the remote controller 30 to output the remote signal IR(˜), the receiving module 18 provides a corresponding format signal If(˜) according to the remote signal IR(˜), and the management module 24 transfers the format signal to the lookup module 22. Therefore, the lookup module 22 can compare the definition of each reference signal stored in the memory module 20 with the format signal If(˜). If the format signal If(˜) complies with a certain reference format signal, the lookup module 22 can transfer the comparison result to the control module 16. Therefore, the control module 16 controls the function module 14 to perform the function. For example, if the user pushes the button K(2) to make the remote controller 30 to output the remote signal IR(2), the lookup module 22 finds out that the format signal If(2), which corresponds to the remote signal IR(2), complies with the reference format signal R(1) stored in the memory module 20. Therefore, the electronic device 12 can start to perform the function F(1). In other words, the electronic device 12 can operate according to the customized remote control mechanism set in the setup mode.

Please note that as mentioned previously in FIG. 1-FIG. 3, the remote controller 30 can be the specific remote controller of the electronic device 12, or any other remote controller. Through the setup mode shown in FIG. 2, the user can redefine the buttons of the specific remote controller. For example, the button K(2) originally corresponds to the function F(2). After the redefining operation is performed as shown in FIG. 2, the button K(2) can newly correspond to the function F(1). In other words, in the present invention, the user can re-define the button function of the specific remote controller, and the user does not have to accommodate himself to the original function of the specific remote controller. Similarly, the remote controller 30 can be another remote controller selected by the user. Therefore, the user can establish a remote control mechanism with a better flexibility.

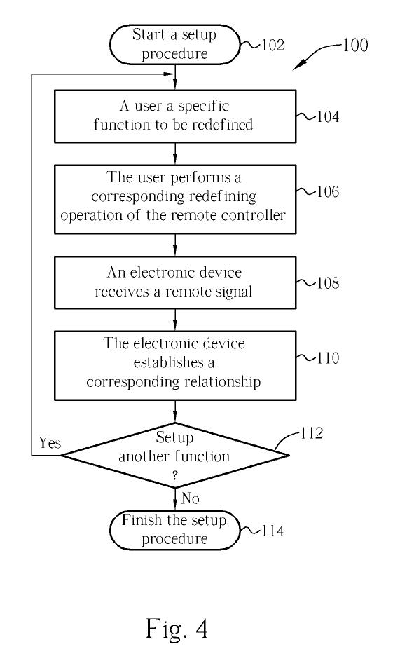

Please refer to FIG. 4 (in conjunction with FIG. 2). The flow 100 shown in FIG. 4 can be regarded as a setup procedure, which is the operation flow of the present invention electronic device 12 in the setup mode. The flow 100 comprises following steps:

Step 102: The electronic device 12 starts the setup mode. When the user wants to establish the customized remote control mechanism, the electronic device 12 can be triggered to be in the setup mode;

Step 104: The electronic device 12 shows each function of the electronic device 12 to the user. The user can select a remote control mechanism corresponding to a specific function to be redefined. In the embodiment of the present invention, the interface module 28 of the electronic device 12 can inform the user by a visual screen or sounds, and allow the user to select the function. For example, if the electronic device 12 is a TV or a display, the electronic device 12 should comprise a screen. In addition, the present invention can utilize the on-screen display (OSD) to inform the user. On the other hand, if the electronic device 12 is a DVD player, the electronic device 12 is coupled to a screen or TV in order to output the images. Therefore, the present invention can utilize the coupled screen to inform the user. Similarly, if the electronic device 12 is a sound player, the electronic device 12 can output sounds by itself or through an external amplifier. Therefore, the present invention can utilize the sounds to inform the user. In fact, the electronic device 12 often comprises a small screen to show the current operation situation. The present invention can surely utilize the small screen to inform the user. Furthermore, the electronic device 12 can comprise buttons (such as the buttons 32 and 36 shown in FIG. 2) such that the user can select a function through the buttons.

Step 106: The user performs the corresponding redefining operation of the remote controller 30 to make the corresponding redefined operation correspond to the function selected in step 104. After the previous step 104 is completed, the electronic device 12 should know which the remote control mechanism is to be reset, and the electronic device 12 can inform the user to start performing the redefining operation. After the electronic device 12 informs the user, the user can perform the redefining operation of the remote controller 30. For example, the user can push a button selected by the user.

Step 108: After the user performs the redefining operation of the remote controller 30 in step 106, the electronic device 12 can receive a remote signal outputted by the remote controller. And then, the electronic device 12 can generate a corresponding format signal according to the related information carried by the remote signal.

Step 110: According to the selected function selected in step 104, the electronic device 12 can utilize the memory module 30 to store the format signal in step 108 as the reference format signal corresponding to the function such that the corresponding relationship between the format signal and the function can be established. Therefore, the “button-remote signal-format signal-reference format signal-function” relationship allows the user to make the redefining operation determined in the step 106 correspond to the function determined in the step 104.

Step 112: After the step 110, the electronic device 12 can inform the user to query the user whether a remote control mechanism corresponding to another function is going to be setup/redefined. If the user wants to perform the redefining operation on another remote control mechanism, the step 104 is performed again such that the user can select another function and redefine the remote control mechanism of the selected function. On the other hand, if the user does not want to perform another redefining operation, the following step 114 can be performed.

Step 114: The electronic device 12 leaves the setup mode such that the flow 100 is completely performed.

And then, the electronic device 12 operates in a normal mode (as shown in FIG. 3) to perform a normal procedure. In the normal mode, the electronic device 12 can detect related information (that is, the format signal) of the remote control signal to see whether the related information complies with a corresponding format signal of each function of the electronic device when receiving the remote control signal of the remote controller 30. Here, if the related information of the remote signal complies with a certain reference format signal, the electronic device 12 can execute the function corresponding to the reference format signal such that the customized remote control mechanism is successfully performed.

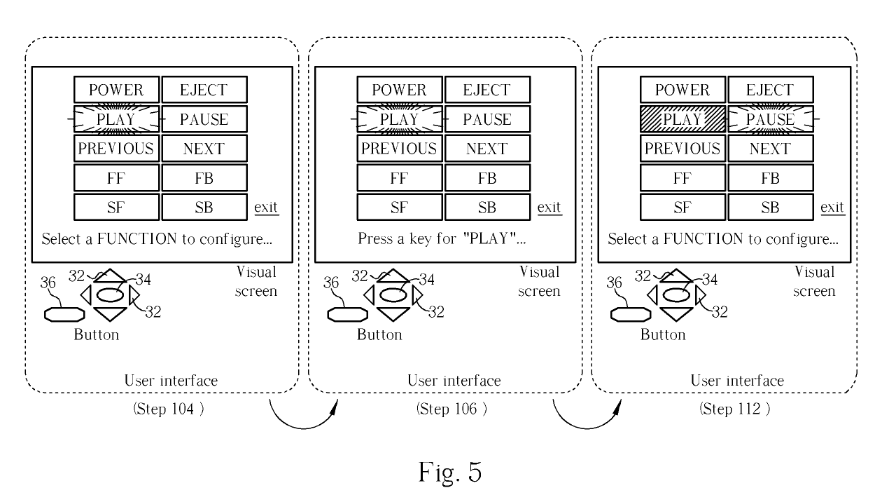

Please refer to FIG. 5 (in conjunction with FIG. 2 and FIG. 4). FIG. 5 illustrates how the electronic device 12 informs the user to perform the flow 100 according to the present invention. In FIG. 5, the user interface is a visual screen utilized to inform the user. In this embodiment, the user can push the button 36 of the interface module 28 (FIG. 2) such that the electronic device 12 operates in the setup mode. In the step 104, the user interface can show each function (such as the functions can be power on/off, disc out, play, pause, next section/previous section, FF/REW, etc. (here, we assume that the electronic device 12 is a DVD player)), which can be remotely controlled, through a visual screen. Furthermore, the visual screen can utilize a notification sentence (such as “select a FUNCTION to configure”) to inform the user to select a function and redefine the remote control mechanism of the function. The user can push the button 32 to select different functions, and the selected function can be highlighted in the visual screen. After the user selects the function to be customized, the user can push the button 34 to confirm. In addition, the flow 100 can go to the step 106.

Here, the selected function is “PLAY”. In the step 106, the user interface can utilize a notification sentence “Press a button “PLAY” to inform the user to perform the redefining (customizing) operation through utilizing the remote controller 30. Therefore, the user can select a button of the remote controller 30, and the button (after the setup operation is completely performed) can be utilized to control the function “PLAY” by the remote controller 30. Here, after the user pushes the button, the flow 100 goes to the following steps 108 and 110, and further to the step 112. In step 112, the user interface can inform each function of the electronic device 12 to the user again such that the user can decide whether to select another function to setup the remote controlling mechanism. On the other hand, the user can decide to leave the setup mode. For example, the user can push the button 36 to leave the setup mode. Another option is for the visual screen to have an “exit” function for the user to push the button 32 to select this option and push the button 34 to confirm the “exit” function. Therefore, the electronic device 12 can leave the setup mode and be back to the normal mode. In the step 112, the visual screen of the user interface can show the function (in FIG. 5, the function is “PLAY”) in a special way in order to represent that the function has been reset. Furthermore, the interface module 28 can also utilize the touch pad to implement the user interface shown in FIG. 5. This makes the user capable of directly selecting desired function through using the touch pad.

In addition, the present invention can inform the user by a sound and help the user to perform the setup procedure of the flow 100. For example, the buttons of the user interface can have numbers such as “1”, “2”, “3”, etc. When the step 104 is being performed, the user interface can make sounds such as “if you want to reset the function “X”, please push the button “1””. Therefore, the user can select the function to be reset. Similarly, when the step 106 is being performed, the user interface can make sounds “please push the desired button of the remote controller” such that the user can perform the redefining operation.

In the above-mentioned user interfaces, the buttons (such as the buttons 32-36 shown in FIG. 5) of the user interface can be utilized to help the operation of the flow 100. These buttons have their corresponding functions on the electronic device 12, or on the specific remote controller of the electronic device 12. In other words, the specific remote controller of the electronic device 12 can have a plurality of function buttons to control the functions of the electronic device 12. In addition, the specific remote controller can each have setup buttons to help the redefining procedure of the flow 100. By utilizing the setup buttons, the user can rearrange the function of each function button of the specific remote controller. Similarly, the user can utilize the setup buttons of the specific remote controller to perform the flow 100 on other remote controllers. Therefore, a typical remote controller can establish the remote control mechanism between the typical remote controller and the electronic device 12.

In another embodiment, the present invention can directly utilize the control pads of the electronic device 12 to implement the user interface in the setup mode. In fact, most of the electronic devices have a control pads, which have each buttons for controlling the specific function of the electronic device. For example, the DVD player has a “play” button to control the DVD playback function, and a “pause” button to control the pause function. Therefore, if the present invention is implemented in this electronic device, when this electronic device operates in the normal mode, these buttons can correspond to the original functions as they are designed. In addition, when the electronic device operates in the present invention setup mode, the user can directly push buttons of the control pads to select the function corresponding to the certain button in step 106. For example, when the user wants to redefine the “play” function of the remote control mechanism, the user can directly push the “play” button of the control pad. The electronic device can know that the user wants to redefine the “play” function according to the controlling operation on the control pad of the user. And then, the user can perform the customized operation on the remote controller in order to reset the remote control mechanism of the “play” function through the step 108 to step 110.

Generally speaking, the remote signal generated by the current remote controller (e.g. infrared ray remote controller) does not have a signal encoding format/protocol. That is, different types of remote controllers often utilize different encoding formats/protocols to carry specific information. In order to support different types of remote controllers and easy for the users to utilize other types of remote controllers to establish the remote controlling mechanism, the present invention electronic device 12 can embed a plurality of different encoding formats/protocols to read remote signals of different formats/protocols and analyzes corresponding format signal from these remote signals.

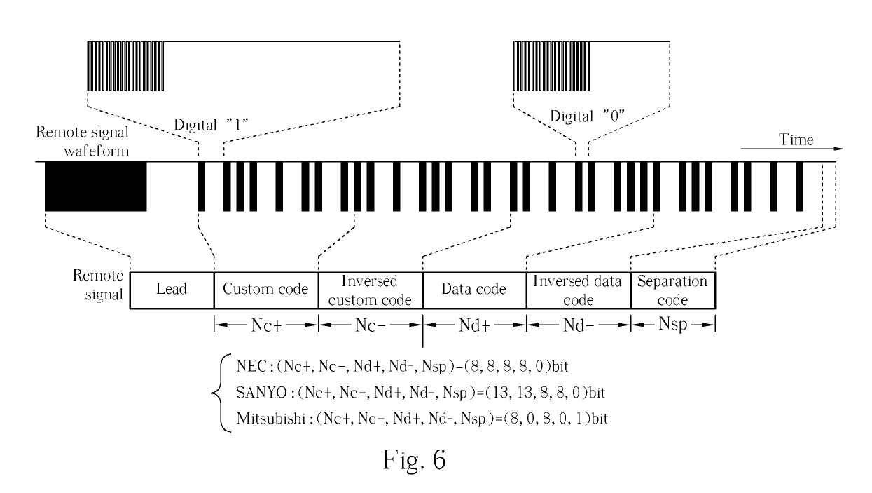

Please refer to FIG. 6, a remote signal carries specific information in different encoding formats/protocols. As shown in FIG. 6, every time the user pushes a button, the remote controller outputs a piece of remote signal, which can be regarded as a packet. In this remote signal waveform, the signal is modulated through a carrier modulation to form a digital “0” and a digital “1” indicated by different waveforms. Through collecting a plurality of waveform pieces, a packet-type remote control signal can be formed. For example, the packet-type remote control signal can comprise a lead, custom code/inversed custom code, data code/inversed data code, and separation code. Here, the custom code/inversed custom code is utilized to identify the remote controller itself, the data code/inversed data code is utilized to carry specific information to identify different remote signals. In other words, in a same remote controller, remote signal packets corresponding to different buttons can have the same custom codes/inversed custom codes. However, the remote signals corresponding to different buttons have different data codes/inversed data codes. Therefore, the different buttons are able to correspond to different remote signals.

However, please note that the remote signal packet outputted by different remote controller in different formats/protocols have different leads. In addition, the other parts of the packet have different bit number. For example, as shown in FIG. 6, in the NEC encoding format/protocol, the custom code/inversed code and the data code/inversed data code are 8 bits, and there is no separation code (the bit number of the separation code is 0). In the SANYO encoding format/protocol, the custom code/inversed code is 13 bit, and the data code/inversed data code are 8 bits. In the Mitsubishi encoding format/protocol, the custom code and the data codes are 8 bits, the separation code is 1 bit. There are no inversed custom code and inversed data code. In addition, other different protocol establishers may provide other remote controllers with different formats/protocols.

In order to widely support remote signals defined by different encoding formats/protocols and allow the user to utilize different types of remote controllers to establish the remote control mechanism with the electronic device 12, the present invention electronic device 12 should have a specific remote signal identifying mechanism such that a corresponding format signal can be extracted from the remote signals defined by different encoding formats/protocols. In a preferred embodiment of the present invention, the remote signal identifying mechanism can embed a plurality of remote signal encoding formats/protocols (for example, the above-mentioned NEC, SANYO, and Mitsubishi encoding formats/protocols). If the remote signal does not belong to these embedded remote signals by encoding formats/protocols, the format signal can be formed through appropriately processing the remote signals (such as sampling the remote signals). In addition, the format signal can be utilized to represent the original remote signals.

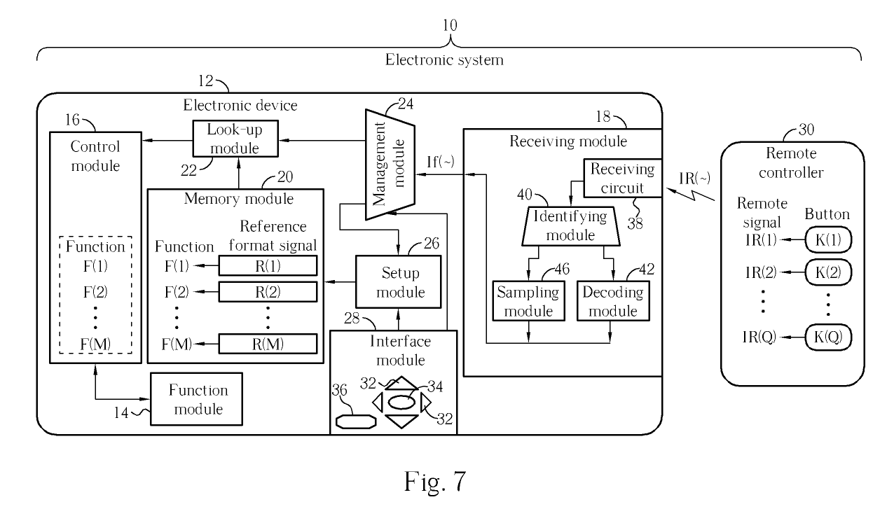

Please refer to FIG. 7 (in conjunction with FIG. 1). FIG. 7 illustrates the remote signal identifying mechanism of the receiving module 18 according to the present invention. In the receiving module 18 of the electronic device 12, the receiving module 18 can further comprise a receiving circuit 38, an identifying module 40, a decoding module 42, and a sampling module 46. The receiving circuit 38 can receive the remote signal as the electronic remote signal, and transfer the electronic remote signal to the identifying module 40. For example, the receiving circuit 38 can comprise a light sensor to detect an infrared-ray remote signal and transform it into an electronic remote signal. The identifying module 40 can determine whether the encoding format/protocol of the remote signal belongs to the embedded encoding formats/protocols according to the electronic remote signal. For example, the identifying module 40 can detect the lead of the remote signal and determine whether the electronic remote signal complies with a certain embedded encoding format/protocol according to the lead. If it does, the electronic remote signal is transferred to the decoding module 42, and the decoding module 42 can perform the decoding operation on the electronic remote signal according to the complied embedded remote signal by encoding format/protocol such that the custom codes and data codes of the remote signal can be obtained. And then, the custom codes and the data codes can be utilized as a format signal corresponding to the remote signal.

Alternatively, if the identifying module 40 determines that the encoding format of the electronic remote signal does not comply with the embedded remote signal formats/protocols, the identifying module 40 transfers the electronic remote signal to the sampling module 46. Therefore, the sampling module 46 samples the waveform of the electronic remote signal (for example, the first rising edge/falling edge can trigger the sampling operation), and a series of sampled digital data can be utilized as the format signal corresponding remote signal. To sum up, the present invention receiving module 18 can obtain related information (especially the digital information) from the remote signal to form corresponding format signal. Therefore, the format signal is able to represent/correspond to the remote signal. In the setup mode, the format signal obtained by the receiving module 18 from the remote signal can be utilized to define the reference format signal corresponding to each function. On the other hand, in the normal mode, the receiving module 18 can compare the format signal obtained from the following remote signal with each reference format signal such that the remote control mechanism can be achieved.

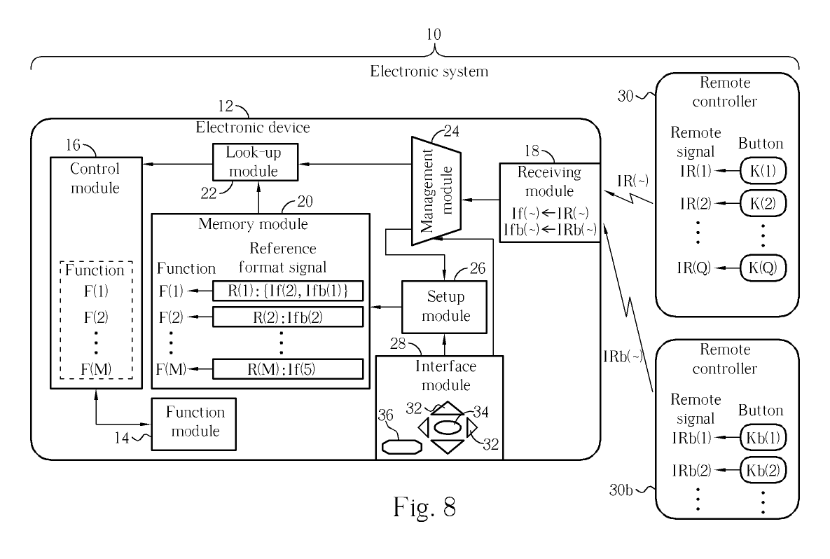

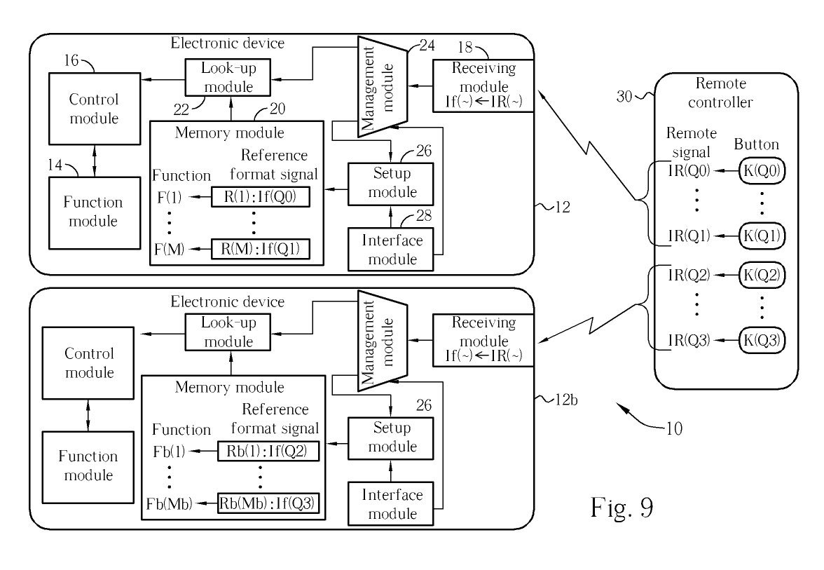

Because the present invention breaks the limitation of the one-to-one relationship between the prior art electronic device and the specific remote controller, the present invention can be implemented as many applications. Please refer to FIG. 8 and FIG. 9 (in conjunction with FIG. 1). FIG. 8 and FIG. 9 illustrate different applications of the present invention. First, as shown in FIG. 8, in the present invention electronic system 10, the user can utilize the present invention technique to utilize different remote controllers (such as the remote controllers 30 and 30b shown in FIG. 8) to remotely control the electronic device 12. Except for the specific remote controller (such as the remote controller 30) of the electronic device 12, the user can utilize other types of remote controllers 30b. That is, the above-mentioned setup mode/procedure shown in FIG. 2 and FIG. 4 can be performed to establish the remote control mechanism between the remote controller 30b and the electronic device 12. For example, the user can select the function F(1) to redefine the remote control mechanism of the function F(1) in the setup mode. And then, the user can push the button Kb(1) of the remote controller 30b to output the remote signal IRb(1), and utilize the electronic device 12 to add the corresponding format signal Ifb(1) to the reference format signal R(1) corresponding to the function F(1). Therefore, the function F(1) can simultaneously correspond to the format signal Ifb(1) and Ifb(2). And the button K(2) of the remote controller 30 and the button Kb(1) of the remote controller 30b can be both utilized to control the function F(1) of the electronic device 12. In other words, if the user is not satisfied with the specific remote controller of the electronic device 12, the user can select another corresponding remote controller. The user can utilize the present invention setup mode/procedure to make some often-used functions of the electronic devices correspond to the buttons of the selected remote controller. In addition, rarely used functions do not have to be set up in the selected remote controller. Therefore, the user can define a better selected remote controller.

As shown in FIG. 9, if the present invention can be utilized in different electronic devices, the present invention can integrate the remote control mechanisms of different electronic devices in a same remote controller. That is, the present invention allows the user to utilize the same remote controller to remote control different electronic devices. In the embodiment shown in FIG. 9, the present invention electronic system 10 comprises not only the electronic device 12, but also another electronic device 12b, which has the same function block diagram as the electronic device 12. Therefore, the electronic device 12b can also operate in a setup mode/normal mode such that the user can establish the customized remote control mechanism. The user can perform the redefining operation on the electronic device 12 to make the buttons K(Q0) to K(Q1) correspond to the function F(1) to F(M) of the electronic device 12. And then, the user can perform the redefining operation on the electronic device 12b make the buttons K(Q2) to K(Q3) correspond to the function Fb(1) to Fb(M) of the electronic device 12b. After the redefining operation, the user can utilize the same remote controller 30 to remotely control different electronic devices 12 and 12b. In this embodiment, the user can integrate the remote control mechanisms of different electronic devices into the same remote controller. For example, the remote control mechanisms of a TV and a DVD player can be integrated in the same remote controller. Therefore, it is more convenient for the user to remotely control different electronic devices by utilizing the same remote controller.

To sum up, in the prior art remote control mechanism, the electronic device can only be remote controlled by the specific remote controller. Therefore, the user has to accommodate himself to the specific remote controller. In contrast to the prior art, the present invention remote control mechanism can allow the user to customize the function corresponding to each button. Even to the extent where the user can utilize other remote controllers. Therefore, the present invention can make the remote control mechanism of the electronic device/system more suitable to the user, and decrease the maintaining cost and time. In the present invention, each module can be respectively implemented by the hardware circuit or software/firmware. For example, in FIG. 1, the lookup module 22, setup module 26, the management module 24, and the control module 16 of the electronic device 12 can be integrated in a same micro-controller, or a micro-controller executes different software or firmware programs to achieve the functions of different modules. In addition, the identifying module 40, the decoding module 42, the sampling module 46, the management module 24, the setup module 26, the lookup module 22 and the control module 16 can be integrated in a micro-controller. Furthermore, except for the remote controller, the present invention can be utilized in other input peripherals such as keyboard/mouse. This allows the user to redefine the control mechanisms between these input peripherals and the electronic device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for providing an electronic device in coordination with a customized remote controller, the method comprising:
showing a user-defined function of the electronic device by a customized operation of the customized remote controller;
receiving a remote signal corresponding to the customized operation of the customized remote controller; and
storing the remote signal as a format signal; wherein the reference format signal corresponds to the given function.

2. The method of claim 1, wherein the step of storing further comprises:
decoding the remote signal according to a predetermined encoding format to obtain a digital content of the remote signal; and
storing the digital content of the remote signal as the reference format signal.

3. The method of claim 1, wherein the step of storing further comprises:
sampling a waveform of the remote signal; and
storing sampling results as the reference format signal.

4. The method of claim 1, wherein the step of storing further comprises:
storing a plurality of predetermined encoding formats;
determining whether a signal format of the remote signal complies with one of the predetermined encoding formats; and
if the format of the remote signal complies with one of the predetermined encoding formats, decoding the remote signal according to the matched encoding format to obtain a digital content of the remote signal and storing the digital content as the reference format signal; and
if the signal format of the remote signal does not comply with any of the predetermined encoding formats, sampling a waveform of the remote signal and storing sampling results as the reference format signal.

5. The method of claim 1 further comprising:
providing the user interface to show a plurality of functions of the electronic device to the user, wherein the functions are set by the user through the user interface; and
after one of user-defined functions is selected, showing the selected function to the user for showing the user how to start the customized operation of the customized remote controller.

6. The method of claim 1 further comprising:
performing electronic device to compare related information of a following remote signal with each format signal; wherein if the related information of the remote signal complies with the corresponding format signal, executing a corresponding function of the format signal by the electronic device.

7. An electronic device capable of working in coordination with a customized remote controller, the electronic device comprising:
a receiving module for receiving a remote signal outputted by the customized remote controller to provide a corresponding format signal according to related information of the remote signal and being capable of receiving the remote signal to provide the corresponding format signal;
a memory module for making each function of the electronic device correspond to each format signal and storing a content of each format; an interface module for providing a user how to select a given function of the electronic device as the signal; and
a management module capable of operating in a setup mode and a normal mode, wherein when the management module operates in the setup mode, the management module can transfer a format signal provided by the receiving module to a setup module.

8. The electronic device of claim 7, wherein the setup module is utilized to set the content of the reference format signal in the memory module.

9. The electronic device of claim 7, wherein when the management module operates in the normal mode, the management module is capable of transferring the format signal provided by the receiving module to a look-up module.

10. The electronic device of claim 9, wherein the look-up module is utilized to compare the corresponding format signal of the receiving module with the reference the format signal, and if the corresponding format signal complies with a certain reference format signal, utilizing a control module to execute a function corresponding to a given reference format.

11. The electronic device of claim 7, wherein the customized remote controller comprises a plurality of buttons, and when each button is pushed, the customized remote controller outputs a corresponding remote signal, and when the management module operates in the setup mode and the user utilizes the interface module to select a given function of the electronic device, the interface module is capable of showing the user to push a customized button of the customized remote controller; and the receiving module is capable of receiving a remote signal corresponding to the customized button and making the management module transfer a format signal corresponding to the remote signal to the setup module.

12. The electronic device of claim 7, wherein the interface module is capable of utilizing a visual picture or sounds to show the user.

13. The electronic device of claim 7, wherein the interface module comprises a plurality of buttons, and the user is capable of pushing each button of the interface module to select the given function.

14. The electronic device of claim 7, wherein the interface module is a touch-controlled display panel to select a customized function.

15. The electronic device of claim 7, wherein the receiving module further comprises:
a receiving circuit for receiving a remote signal of the customized remote controller and providing a corresponding electronic remote signal;
a determination module for determining a signal format of the electronic remote signal complies with one of a plurality of encoding formats stored; and
a decoding module for decoding the remote signal according to the encoding format if the signal format of the electronic remote signal complies with one of the encoding formats in order to obtain a digital content of the remote signal and utilizing the digital content as a format signal corresponding to the remote signal.

16. The electronic device of claim 1 5, wherein the receiving module further comprises:
a sampling module for sampling a waveform of the electronic remote signal if the determination module determines that the electronic remote signal does not comply with any of the encoding formats, and utilizing sampling results as the format signal corresponding to the remote signal.

17. An electronic system with a customized remote control mechanism, the electronic system comprising:
at least one remote controller, wherein each remote controller is capable of being controlled by a user to output a corresponding remote signal; and
at least one electronic device, wherein each electronic device comprises:
a control module capable of controlling the electronic device to execute at least one function;
a memory module capable of making each function of the electronic device respectively correspond to a reference format signal and storing a content of each reference format signal;
a setup module for setting the content of each reference format signal in the memory module;
a receiving module for receiving the remote signal outputted by each remote controller and providing a format signal according to related information of the remote signal;
a management module capable of operating in a setup mode and a normal mode, wherein when the management module operates in the setup mode, the management module is capable of transferring the format signal provided by the receiving module to the setup module, and when the management module operates in the normal mode, the management module is capable of transferring the format signal provided by the receiving module to a look-up module; and
an interface module capable of being operated by the user;
wherein when the management module operates in the setup mode, the user can select a given function of the electronic device through the interface module and the setup module is capable of setting a reference format signal corresponding to the given function according to the format signal transferred by the management module; and when the management module operates in the normal mode, the receiving module is capable of receiving following remote signals and providing corresponding format signals, and the look-up module is capable of comparing the format signal transferred by the management module with each reference format signal; if the format signal complies with a certain reference format signal, the look-up module is capable of making the control module execute a function corresponding to the given reference format.
